(19) United States
(12) Patent Application Publication
(10) Pub. No.: US 2004/0228016 A1
(43) Pub. Date: Nov. 18, 2004

(54) Optical reflecting mirror

(75) Inventor: Eiji Ito, Saitama City (JP)

Correspondence Address: JORDAN AND HAMBURG LLP, 122 EAST 42ND STREET, SUITE 4000, NEW YORK, NY, 10168, US

(73) Assignee: Fuji Photo Optical Co., Ltd., Saitama City (JP)

(21) Appl. No.: 10/842,755

(22) Filed: May 11, 2004

(30) Foreign Application Priority Data
May 13, 2003 (JP) 2003-134028

(51) Int. Cl. G02B 5/08

(52) U.S. Cl. 359/853; 359/838

(57) ABSTRACT

The present invention is implemented to improve the accuracy of a mirror surface and provides an optical reflecting mirror 1 formed by applying injection molding to a plastic material, wherein the surface shape to be a mirror surface 2 includes a curved section A and the thickness t₁, t₂ or t₃ from the front surface 2 to back surface 3 is formed so as to be uniform or substantially uniform as a whole.

### BACKGROUND OF THE INVENTION

1. Field of the Invention

The present invention relates to an optical reflecting mirror.

2. Description of the Related Art

Conventional optical reflecting mirrors having a curved reflecting surface, which is difficult to manufacture from glass, are formed by applying injection molding to a plastic material. However, in molding using a normal injection molding method, the thickness from a mirror surface 100 to a back surface 101 partially varies as shown in FIG. 1, the molding contraction increases as the thickness increases, and it is therefore difficult to improve the accuracy of the mirror surface 100.

Therefore, in order to mold a mirror surface with a high degree of accuracy as described in Japanese Patent Laid-Open No. H9-155928, there is a proposal on a method which molds an optical reflecting mirror shaped in such a way as to connect a body having a mirror surface and a rib which intersects with this body through resin injection into a molding die, places a gate at a position facing the rib and preferentially sinks the rib while cooling and keeping the pressure of the resin. When an optical reflecting mirror is molded, it is generally known that the accuracy of the shape improves by sinking a surface facing the mirror surface of the optical reflecting mirror. Focused on this point, the present invention sinks the side of the rib, and can thereby complement the amount of contraction of the body having the mirror surface and prevent sinks from occurring on the mirror surface and the facing surface of the optical reflecting mirror even if molding is performed at an extremely low pressure.

### SUMMARY OF THE INVENTION

In the aforementioned method described in Japanese Patent Laid-Open No. H9-155928, it is necessary to form the rib to positively cause sinking and this rib sometimes becomes unnecessary or obtrusive depending on the purpose of use. Moreover, conventional examples do not contemplate forming a complicated curved surface used for applications such as a projector and seem to be unable to mold a mirror surface even having an aspherical surface or free curved surface with a high degree of accuracy.

Therefore, it is an object of the present invention to provide an optical reflecting mirror designed to improve the accuracy of the mirror surface having a complicated curved shape used for a projector, etc.

In order to attain the above described object, the present invention provides an optical reflecting mirror formed by applying injection molding to a plastic material, wherein a surface shape to be the mirror surface includes a curved section and the thickness between the front surface and back surface is formed so as to be uniform or substantially uniform as a whole.

The present invention provides an optical reflecting mirror formed by applying injection molding to a plastic material, wherein a mirror surface to be the mirror surface includes a curved section and the thickness between the front surface and back surface is formed so as to be uniform or substantially uniform as a whole, and therefore even if sinks are generated during injection molding, they are not partial but uniform sinks as a whole, and as a result it is possible to prevent warpage or distortion and improve the accuracy of molding even if the mirror surface includes a complicated curved section.

### BRIEF DESCRIPTION OF THE DRAWINGS

FIG. 1 is a cross-sectional view showing a conventional example;

FIG. 2 is a cross-sectional view showing a preferred embodiment of the present invention; and

FIG. 3 is a cross-sectional view showing another embodiment.

### DETAILED DESCRIPTION OF THE PREFERRED EMBODIMENTS

Based on the attached drawings, preferred embodiments of the present invention will be explained below.

The embodiment shown in FIG. 2 is a cross-sectional view of an optical reflecting mirror 1. The surface shape to be a mirror surface 2 of this optical reflecting mirror 1 includes a curved section A and in this case the entire surface constitutes the curved section A and the shape of a back surface 3 also has a concave/convex shape which is opposite to that of the mirror surface 2 and the thickness t₁, t₂ or t₃ from the front surface 2 to the back surface 3 is formed so as to be uniform. The thickness between the front surface 2 and back surface 3 is formed so as to be uniform or substantially uniform as a whole. Furthermore, the shape of the curved section A can be an aspherical surface, spherical surface, free curved surface and paraboloid, etc.

The “thickness” here refers to a distance from an arbitrary position of the mirror surface to a position on the back surface closest in the direction of the optical axis. Furthermore, “thickness being substantially uniform” means that a difference Δt in the thickness between the thickest part and the thinnest part satisfies the following expression over the entire optical effective region of the mirror surface:

Δt≦average of thickness within optical effective region×20%

For example, when the average thickness over the entire optical effective region of the mirror is 5 mm, the thickness is interpreted as substantially uniform as far as the difference between the maximum thickness and minimum thickness is not more than 20% of 5 mm, that is, 1 mm. This range is preferably 10% or less and more preferably 5% or less.

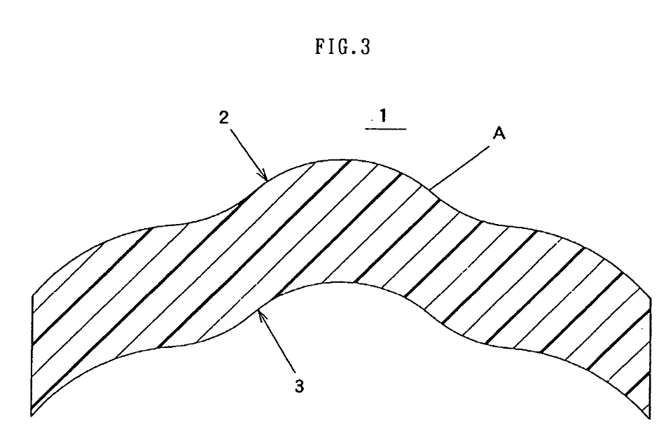

FIG. 3 shows an embodiment of an optical reflecting mirror 1 provided with a mirror surface 2 having a free curved surface as the curved section A. In this case, the thickness between a back surface 2 and back surface 3 is formed so as to be uniform or substantially uniform as a whole. Keeping the thickness uniform means that the surface of the die for molding the back surface 3 has the same shape as that of the mirror surface (front surface) 2.

When a plastic material is molded through injection molding, the molding contraction ratio increases as the thickness increases. That is, when the pressure applied to the cavity of the die is insufficient during molding, a phenomenon like sinks being generated in a part of the maximum thickness is likely to occur. The present invention prevents partial sinks without applying a dwell pressure to the injected plastic material and even if any partial sinks do occur, the present invention can maintain the accuracy of the surface mirror 2 by limiting them to uniform and tiny sinks as a whole. Moreover, keeping the thickness uniform also makes it possible to suppress warpage or distortion.

Silver or aluminum is evaporated onto the surface of the injection-molded plastic, which is formed into a mirror surface. As the mirror forming means, various publicly known means can be adopted.

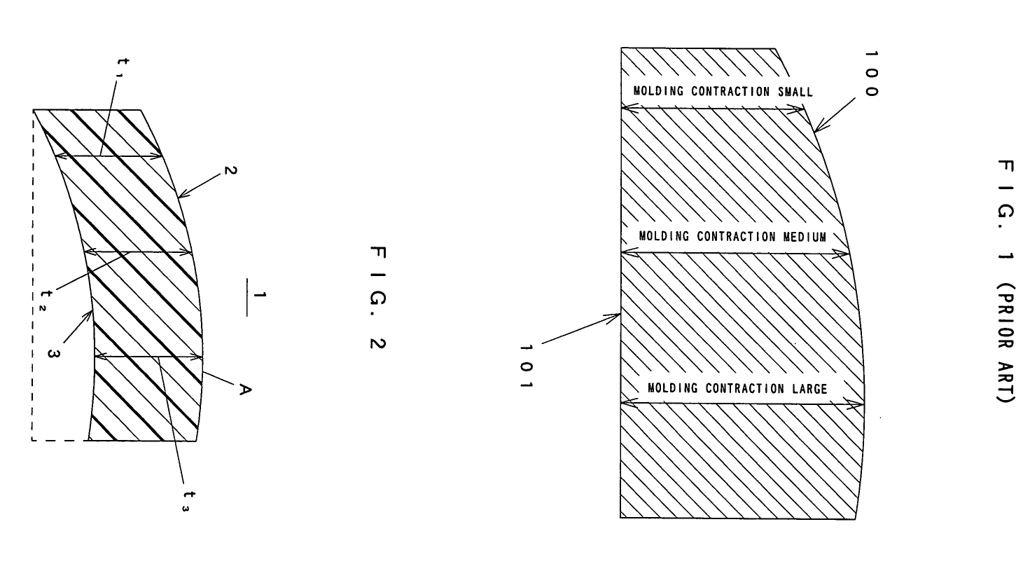

The “surface shape to be the mirror surface 2 having the curved section A” means that the mirror surface may include a partially flat section or the entire surface may also have an aspherical shape as shown in FIG. 1.

What is claimed is:

1. An optical reflecting mirror formed by applying injection molding to a plastic material, wherein the surface shape to be a mirror surface includes a curved section and the thickness between the front surface and back surface is formed so as to be uniform or substantially uniform as a whole.

2. The optical reflecting mirror according to claim 1, wherein said curved section is an aspherical surface or free curved surface.
